(19) United States
(12) Patent Application Publication
(10) Pub. No.: US 2006/0108977 A1
(43) Pub. Date: May 25, 2006

(54) Charging apparatus for charging a wireless operating element of a medical device

(76) Inventors: Robert Kagermeier, Nurnberg (DE); Dietmar Sierk, Erlangen (DE); Reiner Staab, Baiersdorf (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/283,898

(22) Filed: Nov. 21, 2005

(30) Foreign Application Priority Data
Nov. 25, 2004 (DE) 10 2004 056 997.5

(51) Int. Cl. H02J 7/00

(52) U.S. Cl. 320/108

(57) ABSTRACT

The invention relates to a charging apparatus which is connectable or connected to a power source, for charging a wireless operating element of a medical examination and/or treatment device, wherein the charging apparatus includes a charging receptacle having a holder for the operating element and can either be run in a stationary mode for charging the operating element or be carried and operated by a user in a mobile mode during the charging.

### CROSS REFERENCE TO RELATED APPLICATIONS

This application claims priority to the German application No. 10 2004 056 997.5, filed Nov. 25, 2004 which is incorporated by reference herein in its entirety.

### FIELD OF INVENTION

The invention relates to a charging apparatus, which is connectable or connected to a power source, for charging a wireless operating element of a medical examination and/or treatment device and an associated operating unit.

### BACKGROUND OF INVENTION

The operation of medical examination and/or treatment devices, e.g. x-ray devices, is increasingly done by means of wireless operating elements which have batteries that must be recharged from time to time. In this context, the availability of the wireless operating elements is problematic if the charging has been forgotten and the battery is completely discharged. Even in such a case, it is necessary for the operating element to remain available, at least in an emergency mode, e.g. in order to carry out an examination. There must not be any occurrence of perceptible limitations in relation to usability, in comparison with cable-based operating elements which are usually utilized. In addition, applications in the clinical environment have particular requirements relating to the mechanical robustness of a charging apparatus and to its easy and problem-free cleaning and disinfecting, without said requirements resulting in any limitations of the technical functionality. Particularly in the medical field, where work often takes place under considerable time pressure, ease of use and high reliability are exceptionally important.

### SUMMARY OF INVENTION

The invention therefore addresses the problem of specifying a charging apparatus which allows ease of use and works reliably.

In the case of a charging apparatus of the type cited at the beginning, this problem is solved in accordance with the invention, wherein the charging apparatus includes a charging receptacle with a holder for the operating element and can either be run in a stationary mode for charging the operating element or be carried and operated by a user in a mobile mode during the charging.

In accordance with the invention, the operating element is e.g. inserted or pushed into the holder of the charging receptacle and, depending on the requirements at the relevant time, can be run in both a stationary manner, i.e. for merely charging the battery, and a mobile manner, i.e. for operating the medical examination or treatment device while the operating element is charged at the same time. In the stationary mode, as in the case of a charging station, only the charging of the operating element takes place and the operating element is not used. This functionality is effective if the charging apparatus charges the operating element overnight, for example. If the charging was forgotten, however, the claimed charging apparatus allows charging in the mobile mode, during which the medical device can be operated without difficulty at the same time.

Unlike charging cables which can be plugged in directly, the charging receptacle with the holder for the operating element is mechanically robust such that, in particular, the connection to the power source is guaranteed even in the case of tensile loading or impact.

For the purposes of this invention, the charging apparatus is connectable or connected to the power source via a cable. Therefore the charging apparatus can be operated at a certain distance in accordance with the requirements of the structure of the medical examination or treatment device.

In accordance with the invention, the charging receptacle can be designed for positive and/or frictional mounting of the operating element, in particular by means of clamps. Unlike conventional charging stations, a positive or frictional mounting makes it possible to mount the operating element in the charging apparatus in such a way that any slippage or escape in the case of transport or external mechanical effects such as impact is largely prevented. The combination of a positive and a frictional mounting, e.g. by means of clamping the operating element in, additionally increases the security during mobile utilization of the charging apparatus.

The charging receptacle advantageously features a moveable retaining and/or clamping element for clamping the operating element. Such a moveable element can be designed in the form of a so-called snap-in mechanism, for example. In this case, the moveable clamping element is pulled back slightly, the operating element is inserted and the clamping element is released again such that it snaps forward and securely clamps the operating element. Such a mechanism is quick and easy to operate, and at the same time allows secure retention. In addition, moveable retaining elements can be provided in the form of projections which can be bent against a resistance, or simple spring elements.

Furthermore, the charging receptacle and in particular the holder can include a stop, in particular a groove, for mounting the operating element. Such a stop or groove allows the operating element to be simply secured against slipping out of the charging receptacle. For the purposes of this invention, such a guide groove is adapted to the position of the operating element, said operating element being e.g. clamped in or inserted, in such a way that it covers the upper surface of said operating element to some extent, in order to ensure a protection against movements in the vertical direction when the operating element which is held in the charging apparatus is being carried.

In a configuration of the invention, provision is made for the charging apparatus to include mounting means so that it can be mounted when it is run in stationary mode. A fixed stationary location is assigned to the charging apparatus by means of such a mounting, and therefore said charging apparatus has a fixed storage location and does not interfere during cleaning of the room in which the medical device is situated, nor does it even have to be sought before the medical device can be used. This is an additional advantage over conventional plug-in charging cables which do not assign a fixed location to the apparatus that must be charged, as a result of which there is the danger either that said apparatus must be sought, which is costly, or that said apparatus interferes with other examinations for which it is not required. The mounting means for the stationary mode therefore allow a reliable mounting at a fixed predetermined location.

The mounting means can comprise at least a hole for wall mounting and/or at least a clip element for hanging the charging apparatus onto a medical examination and/or treatment device, in particular onto a rail of the device. The charging apparatus can therefore be hung onto suitable mounting elements of a wall mounting by means of the holes, for example. This can be a simple hook, for example, but wall mountings with additional functionality are also available, e.g. with cable holders, dedicated clamping devices or similar. Additionally or alternatively, provision can be made for a clip element for hanging the charging apparatus onto a rail, as provided on many examination tables, for example. Hanging onto a rail, which rail is already known for the mounting of operating elements, offers the advantage that the charging apparatus has its fixed storage location directly at the medical device, and therefore a fixed assignment to the respective devices is established if there is a plurality of devices in one room, for example, and transport of the medical device is therefore simplified if necessary.

The charging apparatus can be designed for inductive charging. This has the advantage that no direct contact is required between the charging apparatus and the batteries. Furthermore, the charging apparatus can be designed for charging by means of electrically isolated contacts. The increased demands in respect of security and reliability in the case of medical applications are therefore satisfied. The charging principle should preferably be chosen to suit the nominal data of the operating element and further specifications, e.g. in respect of the size of the charging apparatus or similar.

The charging apparatus can have spring-loaded contacts for charging. In this case, the spring-loaded contacts allow a simple and at the same time reliable contacting of the corresponding contacts of operating element. Moreover, the charging apparatus can have at least one contact for signal transmission to the medical device. This provides protection against a transmitter failure in the wireless operating element and therefore the operation of the medical device, though limited, is still possible via the charging apparatus using the signals which are transferred via cable. This contact can also be used for function testing of the operating element, e.g. in order to ensure that a transmitter problem actually exists.

In the case of a device for recording radiation patterns, the contact for transmitting signals is advantageously configured for transmitting an emergency radioscopy signal. This allows the examiner to obtain a simple standard recording, in order at least to be able safely to complete the examination procedure, in order to be able nonetheless to implement e.g. a catheter even in the event of technical problems, without there being any risk to the patients. The charging apparatus therefore serves to prevent possible problems which could arise in connection with wireless technology, in order thus to provide additional safety during operation.

The claimed charging apparatus therefore combines the advantages of a stationary and a mobile charging option for the operating element. Not only is provision made for stationary charging, wherein the operating element has a fixed storage location, but the charging apparatus also has a mobile mode in which the battery is charged while, at the same time, the operating element can be carried and used without restriction. The special construction as a charging receptacle with a holder ensures a particular mechanical robustness which is advantageous particularly in the clinical field.

The invention also relates to an operating unit for a medical examination and/or treatment device, which operating unit comprises a charging apparatus as described above and an associated wireless operating element. This operating unit comprises an operating element which is particularly suitable for use with a charging apparatus in accordance with the invention.

In accordance with the invention, the operating element can be a foot switch or a hand control. Such foot switches or hand controls are used in connection with devices for recording radiation patterns, for example, to move the radiation transmitters or receivers as required and start the recording, to move the patient bed or to adjust the radiation duration. Various pedals are used for this purpose in the case of a foot switch, for example, or push buttons or joystick-like elements in the case of a hand control.

The operating element can have charging contacts in the form of flat charging pads. Such flat charging contacts offer the advantage of a relatively large contact surface, such that charging still occurs even if the operating element is not quite precisely installed in the charging receptacle.

The operating unit and in particular the operating element can have charging contacts which are flush with the surface. As a result, the operating element has a face which is flush with the remaining housing of the operating element, thereby significantly simplifying the cleaning or disinfecting. Consequently, there are no prominent edges at which dirt can collect, or which protrude in an interfering manner during operation.

For the purposes of this invention, the operating unit has charging contacts which are impermeable to liquid. This ensures compliance with specifications that apply in the medical field and stipulate specific protection against the ingress of liquids. Operation of the medical device is therefore still possible even if the operating unit comes into contact with significant quantities of liquid. In the case of conventional charging cables, on the other hand, the problem exists that an ingress of liquid cannot reliably be prevented.

It is advantageous if the operating element has contacts, in particular flat contact pads, for signal transmission to the medical device by means of the charging apparatus. These contacts can be used for forwarding an emergency radioscopy signal, for example, in order thus to guarantee a fundamental functionality of the medical device in the event of a failure of the transmitter. One contact can be provided for transmitting the one emergency radioscopy signal in this context, but a plurality of contacts can also be provided for transmitting different signals in order to allow a more extensive operability via cable in the case of particularly critical applications, for example.

Furthermore, the operating unit can be designed to output a status signal, in particular a charging signal. This status signal can result in the illumination of an LED, for example, which shows that charging is currently taking place. However, a signal can also be forwarded to a display, on which the charging which is currently taking place is again shown via a symbol or a text output. The status signal can indicate possible malfunctions of the operating unit, e.g. if the charging contact is subject to frequent interruptions. In the event of a malfunction, it is also possible for this to be indicated by means of an illumination of an LED at the operating element or at the charging apparatus or, after transmission of the signal via a cable, at an external display or at a stationary mounting of the operating unit. Alternatively or additionally, a malfunction can be indicated by means of an acoustic signal.

The operating element is advantageously developed to operate the medical device via radio signals, in particular via infrared signals or in accordance with the Bluetooth standard. The radio connection must be selected according to the application in this case, in order thus to satisfy the requirements for both rapid and reliable transmission of the radio signals. In addition, it must be ensured that malfunctions cannot be caused by other operating elements or other wireless devices which are present in the examination room or in its vicinity.

### BRIEF DESCRIPTION OF THE DRAWINGS

Further advantages and details of the invention are derived from the exemplary embodiments which are illustrated below and with reference to the drawings, in which:

FIG. 1 shows a plan view of an operating unit according to the invention, and

FIG. 2 shows a side view of a charging device according to the invention.

### DETAILED DESCRIPTION OF INVENTION

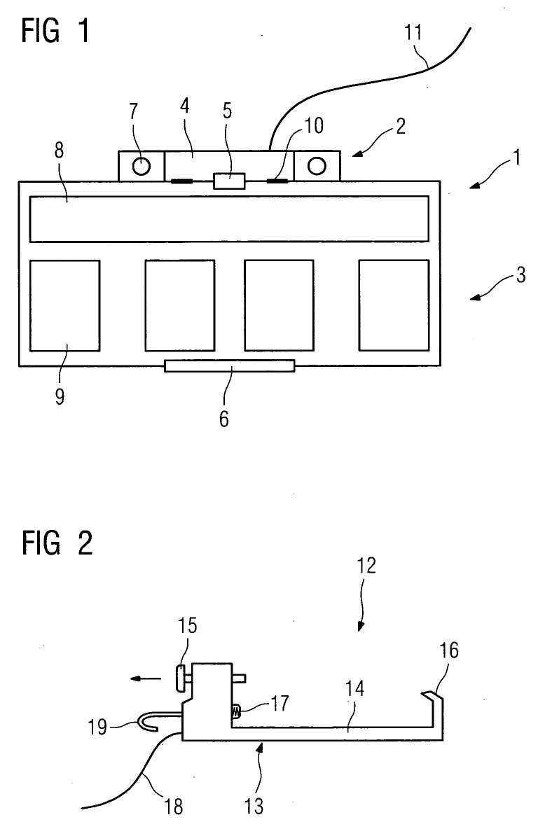

FIG. 1 shows a plan view of an operating unit 1 according to the invention. The operating unit 1 comprises a charging apparatus 2 and an operating element 3 which is a foot switch in this case. The charging apparatus 2 in turn comprises a charging receptacle 4 with a holder for the operating element 3.

The mounting of the operating element 3 takes place by means of a clamping element 5 which is pulled back in order to clamp in the operating element 3 and then snaps forward again after it is released, thereby securely clamping the operating element 3. In addition, the charging receptacle 4 features a groove 6 which is used for guiding the charging receptacle 4 and protects the operating element 3 against slipping out or jumping forwards on the side which is opposite to the clamping element 5. The mounting of the operating element 3 in the charging apparatus 2 therefore takes place via a combination of positive and frictional mounting elements. This allows the unlimited portability of the operating element 3 including charging apparatus 2 in order to operate a medical examination or treatment device even if charging was forgotten, for example.

The charging apparatus 2 additionally has holes 7 which are used for wall mounting the charging apparatus 2 together with an operating element 3 which is clamped therein. The wall mounting of the operating unit 1 has the advantage that a fixed location is assigned for stationary running of the operating unit 1, and therefore the operating unit 1 can easily be found again after it has been tidied away and does not interfere by being in the way when it is not needed.

The operating element 3 has a connection space 8 for the charging electronics and four pedals 9 which are used to operate the medical device. For example, the pedals 9 can be used for moving an image recording device into the correct position, for moving a patient table, or for initiating an image recording. Also illustrated are charging contacts 10, these being designed on the operating element 3 as pads which are flush with the surface and are opposed by spring-loaded contacts on the charging receptacle 4. The connection to the power supply is effected by means of a cable 11 via which signals can also be transmitted from the operating element 3 to the medical device if required, said signals guaranteeing the emergency radiography in the case of an image recording device if there is a failure of the operating element 3 transmitter which is used for radio transmission.

The charging contacts 10 are impermeable to liquid in order to ensure problem-free running of the operating unit 1 in an environment in which the escape of large quantities of liquid can occur under certain circumstances, e.g. the spillage of infusions. The operating element 3 is securely connected to the power source via these charging contacts 10 during mobile use by virtue of the special design of the charging apparatus 2 as a charging receptacle 4 having a holder for the operating element 3.

FIG. 2 shows a side view of a charging apparatus 12 in accordance with the invention. The charging apparatus 12 has a charging receptacle 13 with a holder 14 for the operating element, which operating element is not illustrated here. A secure mounting of the operating element, as per the type of snap-in mechanism which is also known from ski bindings, is guaranteed by the clamping element 15 which is pulled back in the direction of the marked arrow in order to clamp in the operating element. The charging receptacle 13 also includes a groove 16 whose shape is adapted to the shape of the operating element, such that said operating element is protected from slipping out.

The charging of the operating element takes place via the charging contact 17 which is designed as a spring-loaded contact. The charging receptacle 13 is connected to the power source via a cable 18. The charging contacts 17 are electrically isolated for reasons of safety. Not visible here are further contacts which are used for the transmission of signals from the operating element to the medical device in order to allow at least an emergency running of the medical examination or treatment device in the event of a failure of the transmitter of the operating element.

Overall, the charging apparatus 12 is designed in such a way that stationary running is easily possible for charging at a specific location. For this purpose, provision is made here for clip element 19 which is used for hanging onto a rail of a medical device. Alternatively, wall hanging is also possible. At the same time, the charging apparatus 12 is suitable without restriction for mobile use if charging was forgotten. Not only is it possible to satisfy the prescribed impermeability standards in relation to the ingress of liquids, the operating element can also be clamped in easily, in the manner of a ski binding, and is reliably secured in the holder 14 against slipping or jumping out of the charging receptacle 13. The claimed charging apparatus 12 therefore offers crucial advantages in comparison with conventional charging devices, particularly for use in the medical field, in which particular mechanical robustness is required in the context of high safety standards.

1.-20. (canceled)

21. A charging apparatus for charging a wireless operating element of a medical device, the apparatus comprising:
an interface for connecting the charging apparatus to a power source;
a charging receptacle having a holder sized and configured to accommodate the operating element, wherein the charging apparatus includes a stationary operating mode and a mobile operating mode, the stationary operating mode provided for only charging the operating element, and the mobile operating mode provided for both charging and operating the operating element such that the medical device can be operated by the operating element when the charging apparatus is in the mobile operating mode.

22. The charging apparatus as claimed in claim 21, wherein the interface includes a cable.

23. The charging apparatus as claimed in claim 21, wherein the charging receptacle is configured for positive or frictional mounting of the operating element.

24. The charging apparatus as claimed in claim 21, wherein the charging receptacle includes a moveable retaining element for clamping the operating element.

25. The charging apparatus as claimed in claim 21, wherein the charging receptacle includes a groove for supporting the operating element.

26. The charging apparatus as claimed in claim 21, further comprising a mounting unit for supporting the charging apparatus in the stationary mode.

27. The charging apparatus as claimed in claim 26, wherein the mounting unit comprises at least one hole for mounting the charging apparatus on a wall or at least one clip element for attaching the charging apparatus to the medical device.

28. The charging apparatus as claimed in claim 21, wherein the charging apparatus is configured to charge the operating element by inductive charging.

29. The charging apparatus as claimed in claim 21, wherein the charging apparatus is configured to charge the operating element using electrically insulated contacts.

30. The charging apparatus as claimed in claim 21, further comprising spring-loaded charging contacts.

31. The charging apparatus as claimed in claim 21, further comprising at least one contact element for establishing a signal transmission to the medical device.

32. The charging apparatus as claimed in claim 31, wherein the medical device is a medical fluoroscopy image recording system, and the at least one contact element is configured to transmit an emergency radioscopy signal to the medical device.

33. An operating system for operating a medical device, the operating device comprising:
an operating element for acquiring operating commands; and
a charging apparatus for charging the operating element, the charging apparatus comprising:
an interface for connecting the charging apparatus to a power source;
a charging receptacle having a holder sized and configured to accommodate the operating element, wherein the charging apparatus includes a stationary operating mode and a mobile operating mode, the stationary operating mode provided for only charging the operating element, and the mobile operating mode provided for both charging and operating the operating element such that the medical device can be operated by the operating element when the charging apparatus is in the mobile operating mode.

34. The operating system as claimed in claim 33, wherein the operating element is a foot switch or a hand control.

35. The operating system as claimed in claim 33, wherein the operating element includes charging contacts embodied as flat charging pads.

36. The operating system as claimed in claim 33, wherein the operating system and the operating element include charging contacts arranged flush with a surface of the operating system respectively the operating element.

37. The operating system as claimed in claim 33, wherein the operating system has charging contacts configured to be impermeable to liquid.

38. The operating system as claimed in claim 33, wherein the operating element includes at least one contact element for establishing a signal transmission between the medical device and the charging apparatus.

39. The operating system as claimed in claim 33, wherein the operating system is configured to output a status signal related to charging the operating element.

40. The operating system as claimed in claim 33, wherein the operating element is configured to operating the medical device via radio signals, infrared signals or Bluetooth signals.
